(19) United States
(12) Patent Application Publication
(10) Pub. No.: US 2009/0316399 A1
(43) Pub. Date: Dec. 24, 2009

(54) LIGHT EMITTING DIODE

(75) Inventor: CHIA-SHOU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/422,295

(22) Filed: Apr. 13, 2009

(30) Foreign Application Priority Data
Jun. 20, 2008 (CN) 200810067941.1

(51) Int. Cl. F21V 5/04

(52) U.S. Cl. 362/235

(57) ABSTRACT

An LED includes a base, a plurality of chips, a first lens made of a first light penetrable material and a second lens made of a second light penetrable material. The base has a concave depression. The chips are mounted at a bottom of the concave depression. The first lens is received in the depression for encapsulating the chips. The second lens is received in the depression and located on the first lens. The second lens includes a light input surface facing the chips and a plurality of recesses defined in the light input surface corresponding to the chips. Each recess has an internal wall with an uneven surface.

### BACKGROUND

1. Technical Field

The present invention generally relates to light emitting diodes (LEDs), and more particularly to an LED which has a high efficiency of light emission.

2. Description of Related Art

Light emitting diodes (LEDs) are commonly used as light sources in applications including lighting, signaling, and displaying. The LED has several advantages over incandescent and fluorescent lamps, including high efficiency, high brightness, long life, and stable light output. The LED creates much higher illumination and space brightness with less electricity consumption.

A conventional LED generally includes a chip and an encapsulation encapsulating the chip. The encapsulation is made of a transparent or translucent epoxy resin and usually has a flat output surface over the chip. The chip emits light rays towards the flat output surface. Because the encapsulation has a refractive index larger than ambient air, a portion of the light rays will be reflected at the flat output surface and cannot be wholly emitted to outside. Accordingly, the light emitting efficiency of the LED is reduced.

Therefore, there is a need for an LED, which can provide a high efficiency of light emission.

### BRIEF DESCRIPTION OF THE DRAWINGS

FIG. 1 is a cross-sectional view of an LED in accordance with an exemplary embodiment.

FIG. 2 is an explored view of the LED of FIG. 1, wherein the second lens is separated from the first lens.

### DETAILED DESCRIPTION

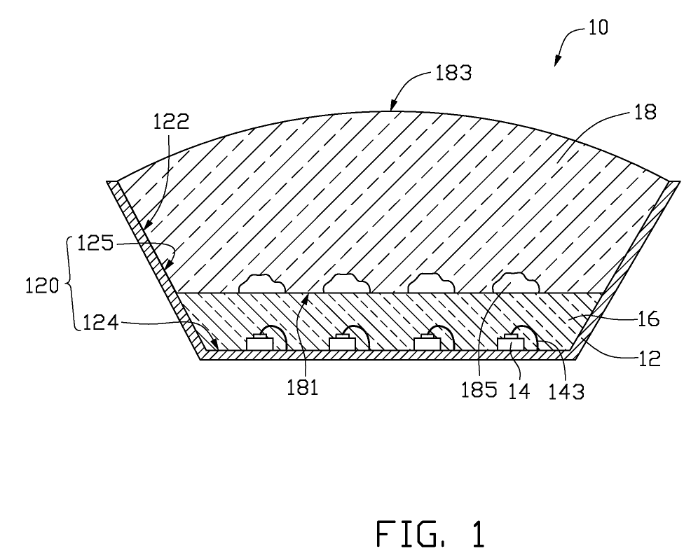

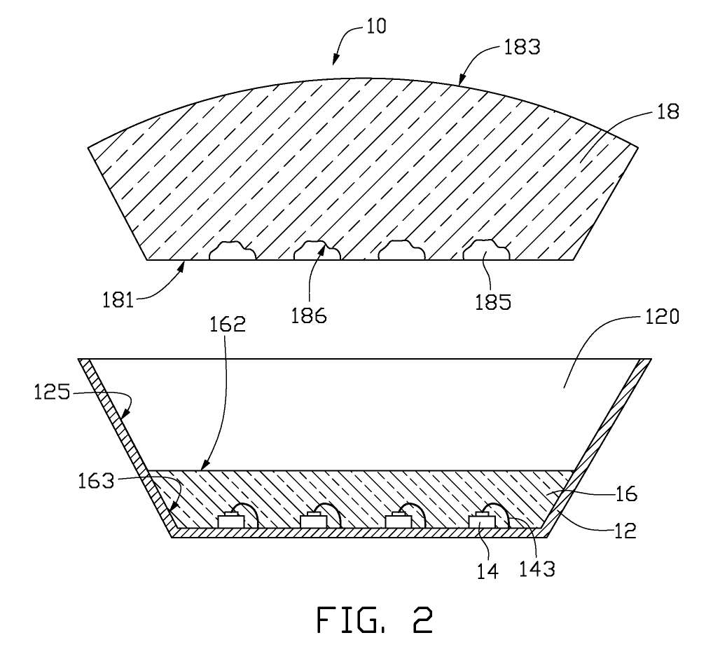

Referring to FIGS. 1 and 2, an LED 10 in accordance with an exemplary embodiment is illustrated. The LED 10 includes a concave base 12, a plurality of chips 14, a first lens 16 and a second lens 18. The chips 14 are disposed in the base 12. The first and second lens 16, 18 are received in the base 12 for sealing the chips 14. The chips 14 are used to emit light rays.

The base 12 has a cup-shaped configuration and has a concave depression 120 defined therein. The depression 120 has a trapeziform cross section 122. The depression 120 includes a flat bottom wall 124 and a sidewall 125 expanding upwardly from a periphery of the bottom wall 124 so that the depression 120 has a narrow bottom portion and a wide top portion.

The chips 14 are disposed on the bottom wall 124 of the base 12 in the depression 120 thereof. The chips 14 are equidistantly spaced from each other and arranged in an array. The chips 14 each electrically connect to the bottom wall 124 via a golden thread 143.

The first lens 16 is received in the depression 120 of the base 12. The first lens 16 is located adjacent to the bottom wall 124 for encapsulating the chips 14. The first lens 16 is made of a first light penetrable material, such as acryl, silicone or epoxy resin. The first lens 16 has a trapeziform cross section similar to that of the depression 120, and has a height smaller than that of the depression 120. The first lens 16 has a flat top surface 162 and a lateral surface 163. The lateral surface 163 abuts intimately against the sidewall 125 of the depression 120. When forming the first lens 16, the light penetrable material is melted and injected into the concave depression 120 of the base 12 and then cooled to form the first lens 16.

The second lens 18 is received in the depression 120 and located on the first lens 16. The second lens 18 is adjacent to a top of the base 12. The second lens 18 has a substantially frustum-shaped configuration. The second lens 18 includes a flat light input surface 181 and a curved light output surface 183. The light input surface 181 is located at a bottom of the second lens 18 for contacting the top surface 162 of the first lens 16. The light output surface 183 is located at a top of the second lens 18 and opposite to the light input surface 181. The light output surface 183 has a convex contour protruding upwardly towards an outside of the LED 10.

The second lens 18 is made of a second light penetrable material. The second light penetrable material can be made by mixing solvent with the first light penetrable material. The second light penetrable material of the second lens 18 has a refractive index, which is smaller than that of the first penetrable material of the first lens 16 and larger than that of ambient air. The second light penetrable material has a melting point lower than the first light penetrable material. The second lens 18 is formed by injecting molten second light penetrable material into a mold and then removing solidified second light penetrable material from the mold to obtain the second lens 18. When mounting the second lens 18 into the depression 120, the first lens 16 is firstly formed in the depression 120, then the second lens 18 is inserted into the depression 120 to be positioned directly on the first lens 16. The first and second lens 16, 18 are then subject to a heat which enables the first and second lens 16, 18 to be securely connected together. The heat has a temperature higher than the melting temperature of the first light penetrable material and lower than the melting temperature of the second light penetrable material.

The light input surface 181 of the second lens 18 defines a plurality of spaced recesses 185 therein. The recesses 185 are arranged in an array similar to that of the chips 14 and respectively correspond to the chips 14 along a vertical direction so that each of the chips 14 is just located under a corresponding recess 185. Each of the recesses 185 has an internal wall 186. The internal wall 186 has an uneven surface.

In operation, light rays are emitted out from the chips 14, then pass through the first lens 16, and then fall incident on the top surface 162 of the first lens 16. Then, the light rays reach the light input surface 181 and the recesses 185 of the second lens 18 through the top surface 162 of the first lens 16. Especially for the light rays incident on the uneven surfaces of the internal walls 86 of the recesses 185, the uneven surfaces of the internal walls 186 can transfer more light rays into the second lens 18 than smooth surfaces because the possibility for an uneven surface to have a total reflection is much lower than that for a smooth surface. Accordingly, most of light rays can be dispersed into the second lens 18. Moreover, the light output surface 183 of the second lens 18 has a convex shape and an incident angle of a convex surface is smaller than that of a flat surface, so that the light rays in the second lens 18 are more easily refracted into the ambient air above the light output surface 183 and the light rays are converged towards a central region above the light output surface 183.

Furthermore, because the second lens 18 is located between the first lens 16 and ambient air, the light rays firstly enter the first lens 16, and then enter the second lens 18 having a smaller index than the first lens 16, and finally reach the ambient air above the LED 10, so that the light loss caused by a total reflection can be greatly reduced.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED comprising:
a base having a concave depression;
a plurality of chips mounted at a bottom of the concave depression;
a first lens made of a first light penetrable material being received in the depression and encapsulating the chips; and
a second lens made of a second light penetrable material being received in the depression and located on the first lens, the second lens including a light input surface facing the chips and a plurality of recesses defined in the light input surface corresponding to the chips.

2. The LED of claim 1, wherein the chips are arranged in an array and the recesses are arranged in an array similar to that of the chips so that the recesses respectively correspond to the chips in a vertical direction.

3. The LED of claim 1, wherein an internal wall of each of the recesses has an uneven surface.

4. The LED of claim 1, wherein the second lens includes a light output surface opposite to the light input surface and facing outside, and the light output surface has a convex contour and protrudes upwardly towards an outside of the LED.

5. The LED of claim 1, wherein the second light penetrable material has a refractive index smaller than that of the first penetrable material and larger than that of ambient air.

6. The LED of claim 1, wherein the second light penetrable material has a melting point lower than that of the first light penetrable material.

7. The LED of claim 1, wherein the depression has a trapeziform cross section, the depression includes a flat bottom wall and a sidewall expanding upwardly from a periphery of the bottom wall.

8. The LED of claim 7, wherein the first lens has a trapeziform cross section similar to that of the depression, the first lens has a flat top surface, and the light input surface is flat.

9. An LED comprising:
a plurality of chips;
a first lens encapsulating the plurality of chips, the first lens comprising an emitting surface for passing of light rays of the plurality of chips through the first lens; and
a second lens having an incident surface attaching to the emitting surface of the first lens and an opposite emitting surface facing an outside of the LED, the incident surface of the second lens defining a recess having an uneven surface at a portion over each of the plurality of chips.

10. The LED of claim 9, wherein the second lens has a refractive index smaller than that of the first lens and larger than that of ambient air.

11. The LED of claim 10, wherein the second lens has a melting temperature higher than that of the first lens.
